(19) United States
(12) Patent Application Publication
(10) Pub. No.: US 2019/0360445 A1
(43) Pub. Date: Nov. 28, 2019

(54) FUEL INJECTION DEVICE

(71) Applicant: HITACHI, LTD., Tokyo (JP)

(72) Inventors: Taisuke SUGII, Tokyo (JP); Eiji ISHII, Tokyo (JP); Kazuki YOSHIMURA, Tokyo (JP); Tomoyuki HOSAKA, Tokyo (JP)

(73) Assignee: HITACHI, LTD., Tokyo (JP)

(21) Appl. No.: 16/477,213

(22) PCT Filed: Nov. 24, 2017
(86) PCT No.: PCT/JP2017/042230

§ 371 Date: Jul. 11, 2019

(30) Foreign Application Priority Data
Feb. 24, 2017 (JP) 2017-032818

(51) Int. Cl. F02M 61/18; B05B 1/30

(52) U.S. Cl. CPC F02M 61/1886; F02M 61/20; B05B 1/3053

(57) ABSTRACT

It is possible to prevent a change in the spray pattern and injection flow rate and an increase of particulate matters in the exhaust gas due to residual fuel left in the vicinity of an injection hole outlet carbonized and adhered as deposit. A fuel injection valve includes a displaceable valve body, a valve seat surface that touches the valve body, and an injection hole cup including at least one injection hole formed on the valve body's tip end side and beyond where the valve seat surface touches the valve body. The injection hole cup includes a low lipophilic portion and a lipophilic portion formed on the injection hole cup's surface, the lipophilic portion is formed inside at least a part of a range in which the low lipophilic portion is formed, and at least one portion of the low lipophilic portion is connected to the injection hole's end portion.

### TECHNICAL FIELD

The present invention relates to a fuel injection device used for an internal combustion engine, such as a gasoline engine, in which a valve touches a valve seat to prevent leakage of fuel and a valve moves away from the valve seat to allow injection.

### BACKGROUND ART

In a fuel injection apparatus for vehicle engines, fuel left in the vicinity of an outlet of an injection nozzle is carbonized in or after injection of fuel, and the carbonized fuel is adhered as deposit. The deposit grows over time during use of the injection apparatus to eventually clog a part of the outlet of the injection nozzle, causing a change in a spray pattern or an injection flow rate. In addition, this deposit causes incomplete combustion and also causes an increase in particulate matters in the exhaust gas. Therefore, it is necessary to decrease the amount of the fuel left in the vicinity of the outlet of the injection nozzle in or after injection of the fuel.

On the other hand, for example, PTL 1 discloses a structure in which a capillary tube is formed in the injection opening area and fuel is spread outside the injection opening area to prevent the fuel from being deposited in the injection opening area.

### CITATION LIST

### Patent Literature

PTL 1: JP 2005-517122 A

### SUMMARY OF INVENTION

### Technical Problem

In the structure described in PTL 1, however, the capillary tube is clogged by the deposit and the effect cannot be achieved if accumulation and deposition of fuel is repeated due to long time operation. Therefore, it is an object of the present invention to solve the problem of forming the deposit and to prevent the deposit.

### Solution to Problem

In the present invention, the above object is achieved by the following measurements.

According to the invention as recited in claim 1, a fuel injection device includes a displaceable valve body, a valve seat surface that touches the valve body to seat fuel, and an injection hole cup in which at least one injection hole is formed on the tip end side of the valve body beyond a position at which the valve seat surface touches the valve body, in which the injection hole cup includes a low lipophilic portion and a lipophilic portion formed on the surface of the injection hole cup, the lipophilic portion formed inside at least a part of a range in which the low lipophilic portion is formed, and at least one portion of the low lipophilic portion is connected to an end portion of the injection hole.

According to the invention as recited in claim 2, in the fuel injection device according to claim 1, the lipophilic portion is formed by one or more approximately columnar projections. According to the invention as recited in claim 3, in the fuel injection device according to claim 1 or 2, the lipophilic portion is made of at least one particulate matter. According to the invention as recited in claim 4, in the fuel injection device according to claim 1 or 3, the lipophilic portion and the low lipophilic portion have different surface roughness values.

According to the invention as recited in claim 5, in the fuel injection device according to claim 1 or 2, at least one of the lipophilic portion or the low lipophilic portion is subjected to a surface treatment to change the lipophilic characteristic. According to the invention as recited in claim 6, in the fuel injection device according to claim 1 or 2, a distance between the lipophilic portions narrows with distance from the injection hole as the lipophilic portions are away from the injection hole when the lipophilic portions are away from the injection hole by more than a predetermined distance.

According to the invention as recited in claim 7, in the fuel injection device according to claim 1 or 2, a distance between the lipophilic portions narrows with distance as the lipophilic portions approach the injection hole by more than a predetermined distance. According to the invention as recited in claim 8, in the fuel injection device according to claim 1, the low lipophilic portion is formed by one or more grooves, and a width of the low lipophilic portion narrows with distance from the injection hole as the low lipophilic portion is away from the injection hole when the low lipophilic portions are away from the injection hole by more than a predetermined distance. According to the invention as recited in claim 9, in the fuel injection device according to claim 1, the low lipophilic portion is formed by one or more grooves, and a width of the low lipophilic portion narrows with distance as the low lipophilic portion approaches the injection hole by more than a predetermined distance.

According to the invention as recited in claim 10, the low lipophilic portion is formed by one or more grooves, and the low lipophilic portion expands approximately radially from the injection hole in at least one of a central direction or an outer peripheral direction of the injection hole cup.

### Advantageous Effects of Invention

According to the present invention, the fuel injection device capable of preventing generation of deposits in the injection hole and in the vicinity of the injection hole outlet, having no change in the spray pattern and the injection flow rate over time, and discharging fewer particulate matters is achieved, whereby the internal combustion engine with improved exhaust performance and fuel consumption performance can be achieved.

Other problems, structures, and effects that have not been described above will be apparent from the following description of the embodiment.

### BRIEF DESCRIPTION OF DRAWINGS

FIG. 1 is a cross-sectional view of a fuel injection device according to an embodiment of the present invention.

FIG. 2 is a cross-sectional view enlarging a portion in the vicinity of a tip end of a valve body of the fuel injection device according to a first embodiment of the present invention.

FIG. 3 is an enlarged view of the fuel injection device according to the first embodiment of the present invention, when seen in a fuel injection direction.

FIG. 4 is a cross-sectional view taken along line B-B′ in FIG. 3 of the fuel injection device according to the first embodiment of the present invention.

FIG. 5 schematically illustrates a portion in the vicinity of an injection hole during fuel injection in a fuel injection device of a reference example.

FIG. 6 schematically illustrates a portion in the vicinity of the injection hole after fuel injection in the fuel injection device of the reference example.

FIG. 7 schematically illustrates a portion in the vicinity of the injection hole during fuel injection after deposit is formed in the fuel injection device of the reference example.

FIG. 8 schematically illustrates a portion in the vicinity of the injection hole when the deposit is formed in the fuel injection device according to the first embodiment of the present invention.

FIG. 9 schematically illustrates a portion in the vicinity of the injection hole when the formation of deposit progresses in the fuel injection device according to the first embodiment of the present invention.

FIG. 10 is an enlarged view of the fuel injection device seen in the fuel injection direction when a small number of lipophilic portions are present according to the first embodiment of the present invention.

FIG. 11 schematically illustrates a portion in the vicinity of an injection hole during fuel injection in a fuel injection device according to a second embodiment of the present invention.

FIG. 12 schematically illustrates a portion in the vicinity of an injection hole during fuel injection in a fuel injection device according to a third embodiment of the present invention.

FIG. 13 schematically illustrates a portion in the vicinity of an injection hole during fuel injection in a fuel injection device according to a fourth embodiment of the present invention.

FIG. 14 schematically illustrates a portion in the vicinity of an injection hole during fuel injection in a fuel injection device according to a fifth embodiment of the present invention.

FIG. 15 is an enlarged view of a fuel injection device according to a sixth embodiment of the present invention when seen in the fuel injection direction.

FIG. 16 is an enlarged view of a fuel injection device according to a seventh embodiment of the present invention when seen in the fuel injection direction.

### DESCRIPTION OF EMBODIMENTS

In the following, embodiments of the present invention will be described by referring to the accompanying drawings. In the present invention described below, the respective effects can be combined to obtain a synergy effect. Therefore, an embodiment of the present invention can be achieved by combining the structure of an embodiment with the structure of another embodiment.

### First Embodiment

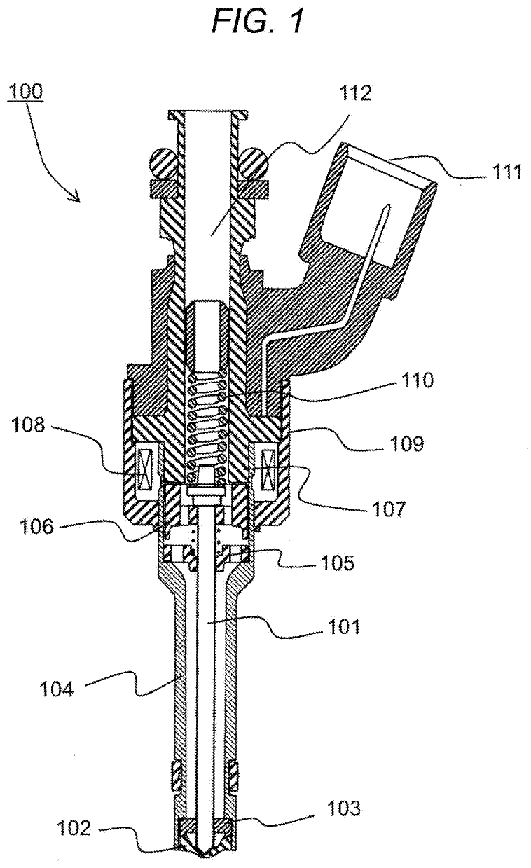

First, the structure of a first embodiment of the present invention will be described by referring to FIGS. 1 to 3.

FIG. 1 is a cross-sectional view of an exemplary electromagnetic fuel injection device as an example of a fuel injection device according to the present embodiment. A basic operation of the injection device is described by referring to FIG. 1. In FIG. 1, fuel is supplied from a fuel supply inlet 112 to the interior of the fuel injection device. An electromagnetic fuel injection device 100 (which may also be called an electromagnetic fuel injection valve) illustrated in FIG. 1 is a normally-closed type electromagnetic-drive device in which a valve body 101 is biased by a spring 110, when a coil 108 is not energized, and pressed against an injection hole cup 102 which is bonded to a nozzle body 104 by welding or the like to seal the fuel. At this time, a fuel pressure supplied to the fuel injection device for cylinder injection is approximately in a range from 1 MPa to 50 MPa.

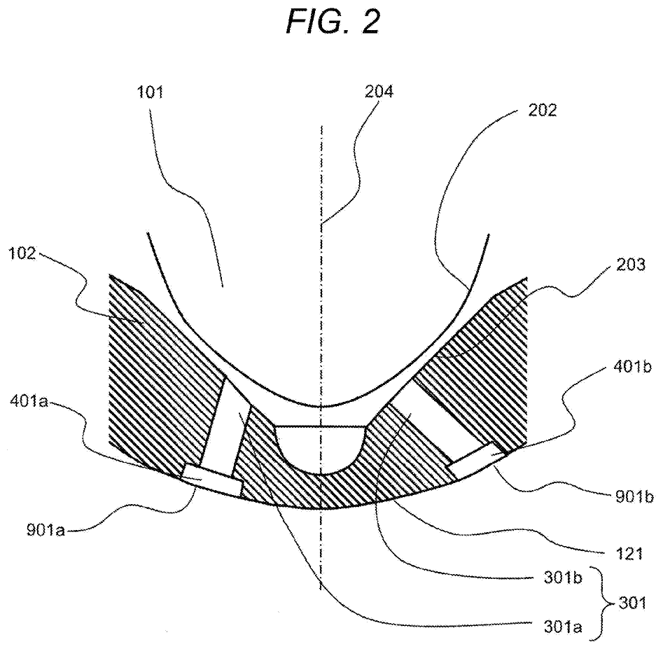

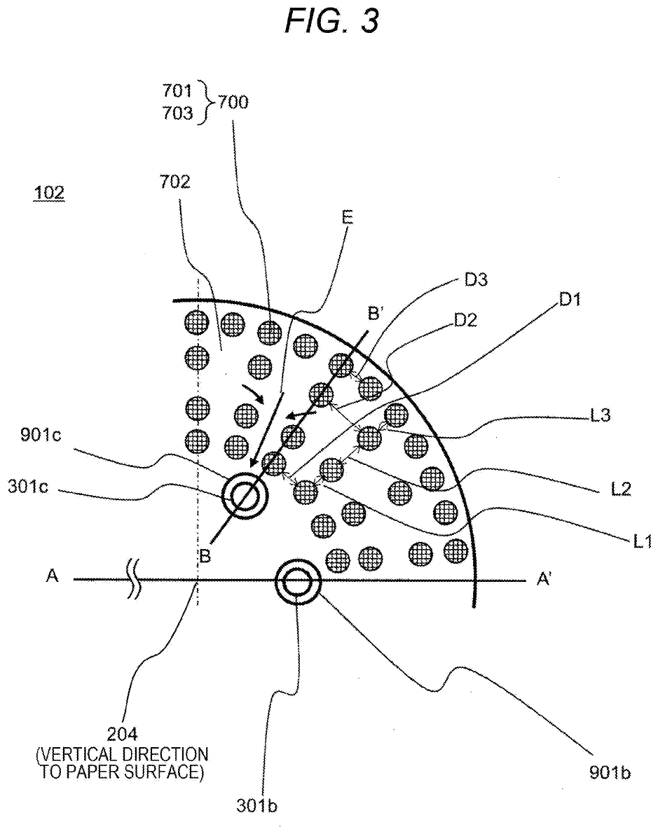

FIG. 2 is an enlarged cross-sectional view of the tip end of the valve body taken along line A-A′ in FIG. 3. FIG. 2 illustrates a central axis 204 of the valve body 101 which is coaxial with the central axis of the fuel injection device 100. When the fuel injection device is in a valve closed state, the valve body 101 touches a valve seat surface 203 formed by a conical surface on an injection hole cup 102, which is bonded to a nozzle body 104 by welding or the like, to keep sealing the fuel. At this time, a contact portion on the valve body 101 side is formed by a curved surface 202, so that the valve seat surface 203 and the curved surface 202 are nearly in a line contact state. When electricity is supplied to the coil 108 of FIG. 1, a core 107, a yoke 109, and an anchor 106, which are constituent components of a magnetic circuit of the electromagnetic valve, generate a magnetic flux density in the anchor 106 to eventually generate a magnetic attractive force in a gap between the core 107 and the anchor 106. If the magnetic attractive force comes to exceed the force generated by a biasing force of the spring 110 and the fuel pressure, the valve body 101 is guided by a guide member 103 and a valve body guide 105 and attracted toward the core 107 by the anchor 106, and enters a valve open state.

In the valve open state, a gap is formed between the valve seat surface 203 and the curved surface portion 202 of the valve body, and the fuel injection starts. When the fuel injection starts, the energy provided as a fuel pressure is converted into kinetic energy which then moves the fuel to reach the injection hole 301 for injection into the air. In the present embodiment, a plurality of injection holes 301 is provided and denoted as 301a and 301b in the drawing. A counterbore portion 401 is formed in each injection hole 301 of the present embodiment, and a first injection hole 301a and a second injection hole 301b respectively have the counterbore portions 401a and 401b on the downstream side in the injection direction. The fuel is injected into the air after passing through the injection holes 301 and the counterbore portions 401. Further, the counterbore portions 401a and 401b have openings 901a and 901b, respectively, on an injection hole cup surface 121.

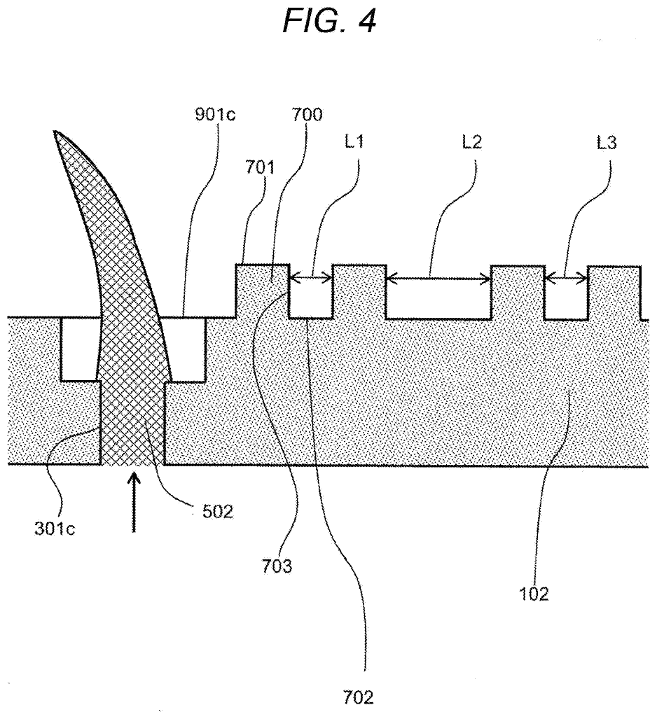

FIG. 3 illustrates the fuel injection device according to the first embodiment of the present invention when seen in the fuel injection direction. The injection hole 301b, which is also illustrated in FIG. 2, and a portion of the injection hole cup 102 around the injection hole 301c not illustrated in FIG. 2 are illustrated. The surface 121 of the injection hole cup 102 includes a plurality of columnar projections 700 and portions other than the columnar projections 700, which are equivalent to low lipophilic portions 702. A cross-sectional view taken along line B-B′ of FIG. 3 is illustrated in FIG. 4. The columnar projections 700 each formed by a lipophilic portion 701 formed as a flat surface and a columnar side surface portion 703. The lipophilic portion 701 has a relatively higher lipophilic characteristic than the low lipophilic portion 702. As used herein, in the present embodiment, the lipophilic portion refers to a portion having a better affinity between fuel and wall surface than the low lipophilic portion, so that, if the fuel droplet is left statically, its contact angle is relatively smaller on the lipophilic portion. On the other hand, the low lipophilic portion represents a portion having a relatively smaller affinity between fuel and wall surface than the lipophilic portion, and has a larger contact angle of the fuel than the lipophilic portion. Further, in FIG. 4, L1, L2, and L3 are distances between the columnar projections 700 on the inner circumference, the middle circumference, and the outer circumference, respectively, in an approximately radial direction. D1, D2, and D3 are distances between the columnar projections 700 on the inner circumference, the middle circumference, and the outer circumference, respectively, in an approximately circumferential direction.

The fuel injection device of the present embodiment includes a displaceable valve body 101, a valve seat surface 203 that touches the valve body 101 to seat fuel, and an injection hole cup 102 including at least one injection hole 301 formed on the valve tip end side beyond a position at which the valve seat surface 203 touches the valve body 101. As illustrated in FIG. 3, the surface of the injection hole cup 102 includes the low lipophilic portion 702 and the lipophilic portion 701 formed inside at least a part of the range in which the low lipophilic portion 702 is formed, in which at least one portion of the low lipophilic portion 702 is connected to the end of the injection hole 301. Further, as illustrated in FIG. 4, the lipophilic portion 701 includes one or more approximately columnar projections.

As illustrated in FIG. 3, it is desirable that the distance between the lipophilic portions 701 decreases with distance as the lipophilic portions 701 are away from the injection hole 301 by more than a predetermined distance. It is also desirable that the distance between the lipophilic portions 701 decreases with distance as the lipophilic portions 701 approach the injection hole 301 by more than a predetermined distance. The low lipophilic portions 702 form a flow passage to the injection hole 301 radially inward to the injection hole 301, while the lipophilic portions 701 surround or form both sides of the flow passage in the circumferential direction. It is important to form the low lipophilic portions 702 so that the flow passage to the injection hole 301 is not blocked by the lipophilic portions 701.

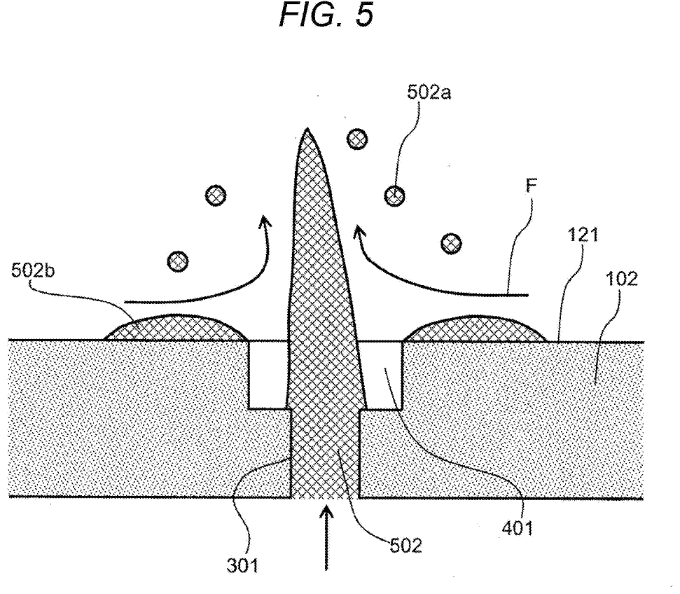

Next, how deposits are formed from fuel 502 is described by referring to FIGS. 5 to 7. FIG. 5 schematically illustrates a portion in the vicinity of the injection hole 301 of a fuel injection device of a reference example during spraying before the deposit is formed. As illustrated in FIG. 5, during injection, the fuel 502 breaks up into a large number of microdroplets 502a. Further, adhered fuel 502b is formed on the injection hole cup surface 121. The adhered fuel 502b is formed by adhesion of the microdroplets 502a on the air flow induced by spraying, or by wet-spreading of the fuel 502 through the counterbore portion 401. Arrows F in FIG. 5 represent airflow near the injection hole formed by spraying. Similarly to the airflow F, airflow is formed around the injection hole in the direction from the outside the injection hole into the injection hole, causing the adhered fuel 502b to be pushed back to the injection hole, partially merge with the fuel 502, and be sprayed. As described above, the airflow F has a cleaning effect of reducing the adhered fuel 502b.

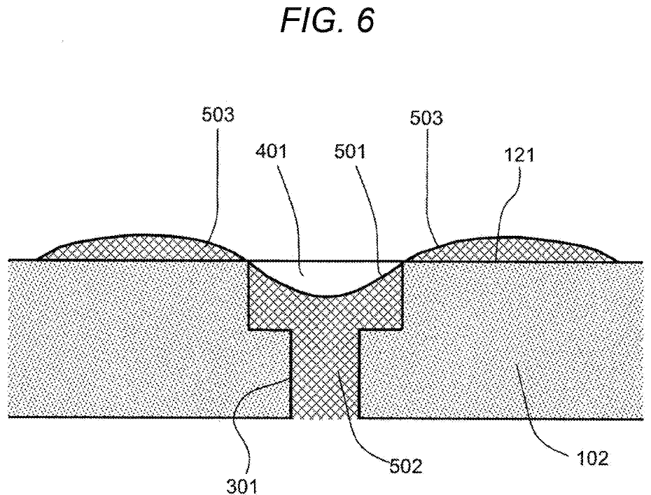

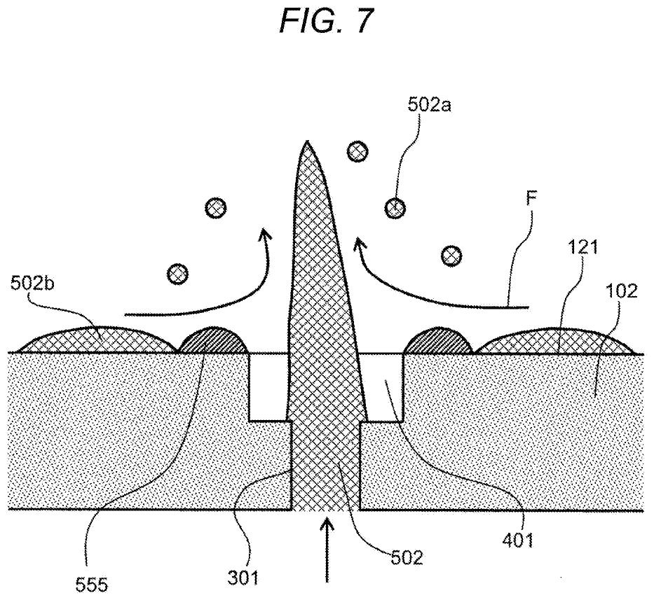

FIG. 6 schematically illustrates a state in which the adhered fuel 502b adheres as a liquid film 503 on the injection hole cup 121 at the end of fuel injection in the reference example. The airflow F described above cannot clean up all the adhered fuel 502b, and some are left as the liquid film 503. In addition, residual fuel 501 is formed inside the counterbore portion 401. The liquid film 503 and the residual fuel 501 dry and deteriorate over time to form deposits on the injection hole cup 121 or in the counterbore portion 401. FIG. 7 illustrates a state of the fuel injection after a deposit 555 is formed. Although the adhered fuel 502b is present on the injection hole cup surface 121, the movement of the adhered fuel 502b is restricted by the presence of the deposit 555. In other words, the cleaning effect by the airflow F is weakened compared to before when the deposit is formed as illustrated in FIG. 5.

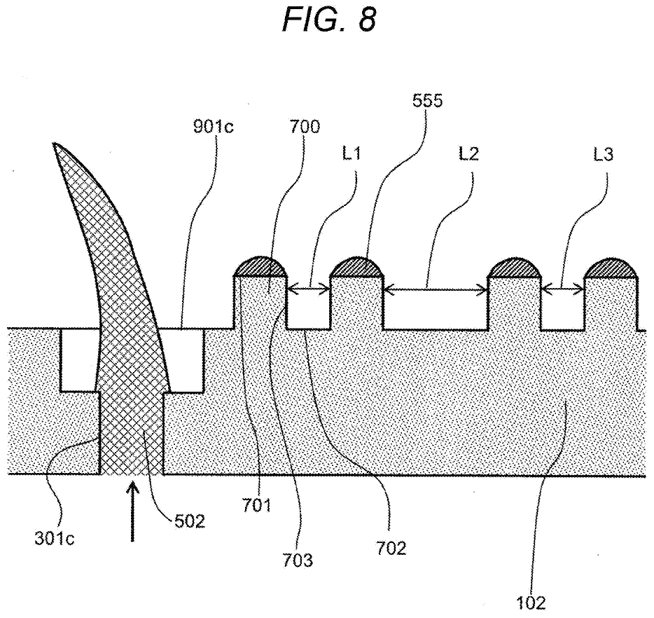

On the other hand, in the present embodiment, the fuel wets and spreads preferentially in the lipophilic portion 701. In addition, the temperature of the low lipophilic portion 702 is lower than the temperature of the lipophilic portion 701, because the low lipophilic portion 702 is less likely to be exposed to a combustion gas compared to the lipophilic portion 701. As a result, as illustrated in FIG. 8, the deposit 555 is preferentially formed on the lipophilic portion 701. For this reason, the deposit is hardly formed on the columnar side surface portions 703 and the low lipophilic portions 702, so that the clean state is maintained. Even when a large amount of adhered fuel is present and excess fuel exists more than the wet-spreading fuel on the lipophilic portions 701, the fuel remains in the liquid state and flows in the injection direction by the airflow formed by injection, as indicated by arrow E in FIG. 3, if the fuel is adhered to the low lipophilic portions 702. Since the low lipophilic portion is connected to an opening 901, the fuel passes through the low lipophilic portion 702, merges with the spray, is removed from the injection hole cup surface 121 along with spraying, and cleaned. Therefore, in the embodiment of the present invention, it is possible to reduce the total deposit formation amount as compared to the reference example.

Here, the lipophilic portions 701 exist inside (in the direction closer to the injection hole) toward the injection hole from at least a part of the range in which the low lipophilic portion 702 is formed. Usually, when the fuel adheres to the tip end of the injection device, the fuel adheres in an approximately circular shape centering on the injection hole. Therefore, the presence of the lipophilic portions 701 on the inner side makes it possible to cause the fuel to be reliably adhered on the lipophilic portions.

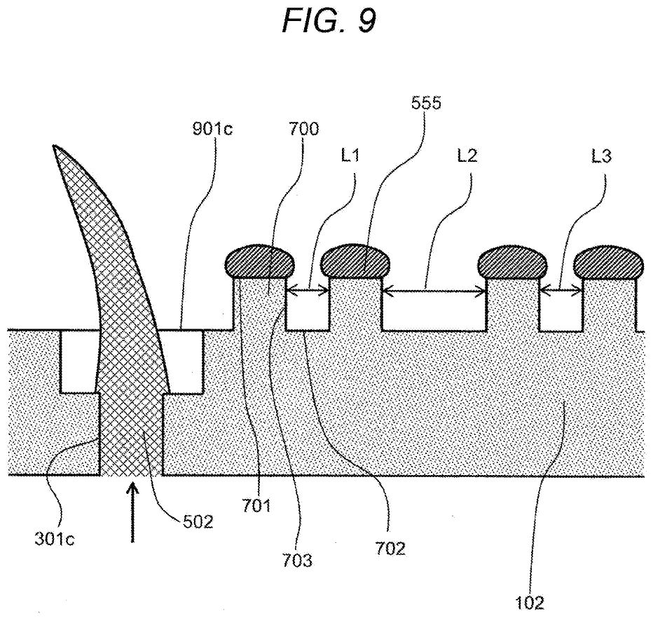

FIG. 9 illustrates a state in which the deposit formation has progressed further compared to the state illustrated in FIG. 8. In the present embodiment, the deposit is formed on the lipophilic portions 701 each having a limited area, so that the deposit tends to grow in an approximately spherical shape as illustrated in the drawing. Therefore, the adhesion area per deposit volume is smaller and the adhesion force is weaker compared to the reference example. As a result, the deposit 555 is easily detached from the injection hole cup 102 when a fluid force to peel off the deposit is exerted on the deposit. Here, the fluid force refers to at least one of a force received from a gas (airflow) and a force received from a liquid (fuel).

Further, in the present embodiment, as illustrated in FIG. 3, the magnitude relationship of the distances L1, L2, and L3 between the columnar projections 700 in the approximately radial direction is L1<L2>L3, as illustrated in FIG. 3. With respect to the distances D1, D2, and D3 in the approximately circumferential direction between the columnar projections 700, the magnitude relationship is D1<D2>D3. Accordingly, the fuel adhered to the low lipophilic portion 702 can easily flow to a thinner flow path due to the capillary effect, so that the fuel tends to flow in both directions toward and away from the injection hole.

The principle of wet-spreading to thinner channels by capillary effect is briefly described below. In general, a pressure difference ΔP occurs at the interface of two types of fluid. This pressure difference is referred to as Laplace pressure and is represented by the equation below.

$$Δ P = γ ( \frac{1}{R} + \frac{1}{{R}^{′}} ) \qquad [ Math . 1 ]$$

where ΔP is a pressure difference, γ is a surface tension, and R and R′ are principal radii of curvature of the interface. In the vicinity of the interface having the curvature, the pressure reduction occurs as defined in the above equation, so the liquid flows toward the pressure reduction section. From the above equation, the smaller the main distance ratio radius R, R′ of the interface, that is, the smaller the flow channel diameter, the larger the pressure difference, and the more easily the liquid flows. Therefore, for example, when the distance between the columnar projections 700 in the approximately radial direction is in the relationship of L1<L2>L2, the liquid easily flows in both directions toward and away from the injection hole.

Here, in the present embodiment, the reason for facilitating the liquid flow in both directions toward and away from the injection hole is as follows. First, by flowing the liquid in the direction of the injection holes to some extent, the cleaning effect by the injection can be enhanced. On the other hand, the injection time in a general fuel injection device is limited, and cleaning by injection is also performed within a certain limited time. Therefore, the fuel that has not been cleaned within the injection time tends to remain in the vicinity of the injection hole. Therefore, the present embodiment has allowed the fuel to easily flow near the injection hole and, at the same time, the fuel is also made to flow by the capillary effect in the direction away from the injection hole in order to prevent the excess fuel from coming close to the injection hole. In the present embodiment, L1<L2>L3 and D1<D2>D3 are used, but the distance between the columnar projections not necessarily follows this relation, and may be, for example, L1<L2<L3 or L1=L2=L3. It is desirable that the distance between the columnar projections be determined so as to bring the fuel that can be cleaned by the cleaning effect close to the injection hole, and the surplus to move away from the injection hole. That is, the determination is based on the amount of adhered fuel, the area of adhered fuel, the magnitude of the cleaning effect, and the like.

The columnar projections 700 can be formed, for example, by etching, rolling, pressing, cutting, and the like. The affinity with fuel may be changed, for example, physically by changing the surface roughness, or chemically by surface treatment (film forming) or the like. For example, to execute the surface treatment, the lipophilic portion 701 may be subjected to a lipophilic treatment by a roller after performing a low lipophilic film formation treatment over the entire injection hole cup 121. Alternatively, the low lipophilic portion may be formed by masking a specific portion and applying a fluorine-based surface treatment. In the present embodiment, the lipophilic portion and the low lipophilic portion are only relatively different in affinity to fuel. Therefore, both the lipophilic treatment and the low lipophilic treatment are not necessarily required, and either treatment may be used.

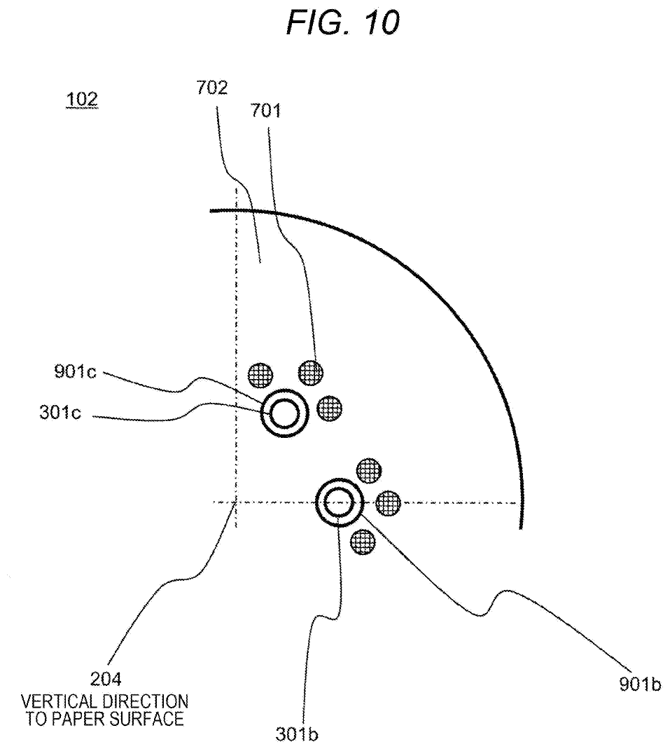

Further, in the present embodiment, the radii and heights of the columnar projections 700 may not necessarily be single values, and may be distributed. In addition, the connection portion between the columnar projections 700 and the low lipophilic portion 702 may be a curved portion (portion R). Further, in the present embodiment, the number of columnar projections 700 is not limited. As illustrated in FIG. 10, a small number of columnar projections 700 may be provided in the vicinity of the injection hole 301.

As described above, in the embodiment according to the present invention, the surface 121 of the injection hole cup 102 is provided with the low lipophilic portions 702 and the lipophilic portions 701, in which the lipophilic portions 701 are formed on the injection hole side from at least a part of the low lipophilic portions 702. In addition, at least a part of the low lipophilic portions is connected to the opening 901. As a result, the fuel wets and spreads preferentially to the lipophilic portions, causing deposit formation. The liquid state is maintained in the low lipophilic portions having a relatively low temperature, and the cleaning effect by the injection can be maintained. Thus, it is possible to reduce the total deposit formation amount as compared to the reference example. Therefore, the fuel injection device having no change in the spray pattern and the injection flow rate over time and discharging fewer particulate matters is achieved, whereby the internal combustion engine with improved exhaust performance and fuel consumption performance can be achieved.

### Second Embodiment

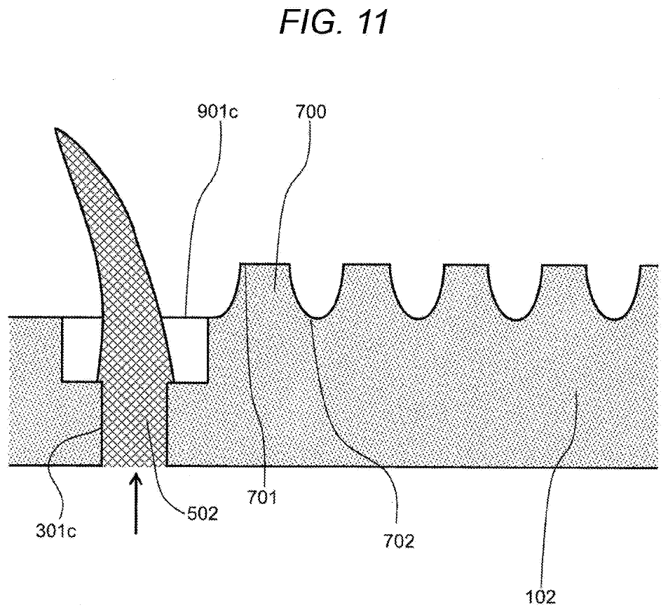

FIG. 11 illustrates a second embodiment according to the present invention. In the present embodiment, as illustrated in the drawing, the radius decreases with distance from the injection hole cup 102. This increases the processing ability by rolling, pressing, and the like.

### Third Embodiment

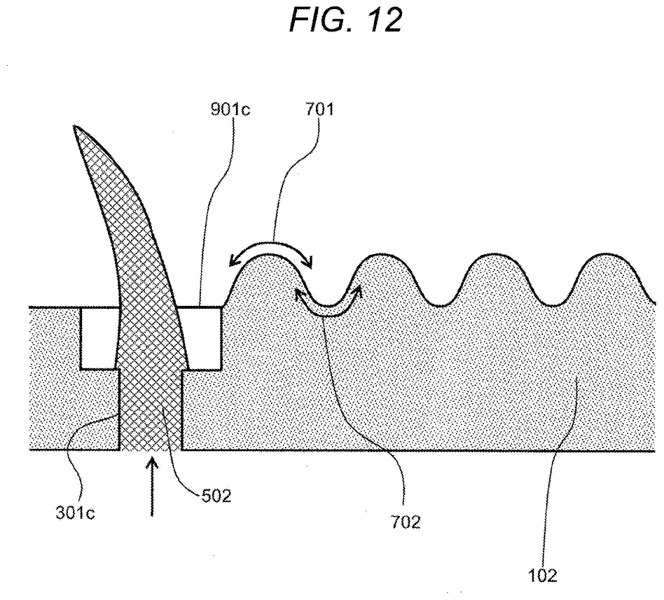

FIG. 12 illustrates a third embodiment according to the present invention. In the present embodiment, the lipophilic portion 701 and the low lipophilic portion 702 are formed by curved surfaces and are connected continuously. This increases a transfer speed of the fuel from the low lipophilic portion 702 to the lipophilic portion 701, and the deposit can be reduced. In the present embodiment, the lipophilic portion 701 is projecting, but may not be projecting and in, for example, a groove shape.

### Fourth Embodiment

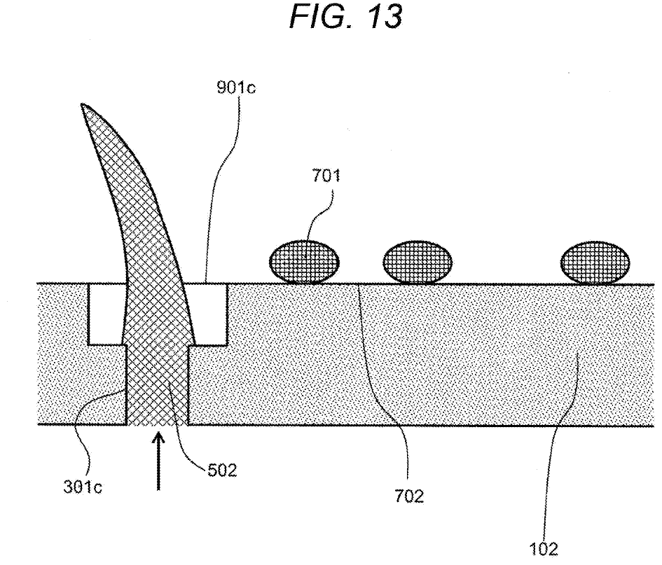

FIG. 13 illustrates a fourth embodiment according to the present invention. In the present embodiment, the lipophilic portion 701 is made of at least one particulate matter. In this case, particulates made of a material having a higher lipophilic characteristic than the low lipophilic portion 702 may be dispersed and fixed by baking, film forming, adhering, or the like. Alternatively, after the particulate material is dispersed and fixed, the lipophilic portion may be formed by the surface treatment, for example, to increase the affinity between the particulate matters and the fuel. In other words, in the present embodiment, at least one of the lipophilic portion 701 and the low lipophilic portion 702 is subjected to surface treatment to change the lipophilic characteristic.

### Fifth Embodiment

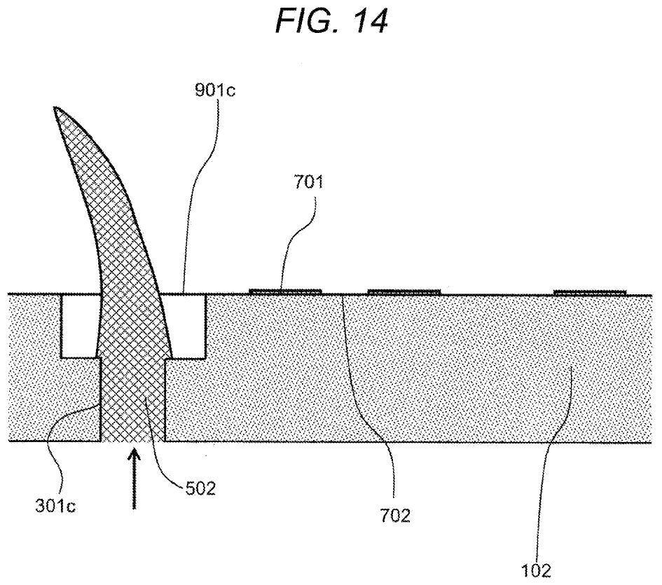

FIG. 14 is a fifth embodiment according to the present invention. In the present embodiment, a lipophilic film forming processing is executed on the surface 121 of the injection hole cup 102 to form the lipophilic portion 701. In the present embodiment, the lipophilic film forming processing is executed, but may not be executed. Alternatively, low lipophilic film forming processing for a lower lipophilic characteristic which is lower than the lipophilic characteristic of the surface 121, for example, may be executed to form the lipophilic portion and the low lipophilic portion. In addition, the lipophilic characteristic may be changed by changing the surface roughness, instead of the film forming processing. In addition, the lipophilic characteristic may be changed by changing the surface roughness, instead of the film forming processing. Here, the relationship between the surface roughness and the lipophilic characteristic is determined by the type of fuel, surface, and the like. For example, when the contact angle between the fuel and the surface is smaller than 90 degrees and the surface is easily wet, the contact angle can be further reduced by decreasing the surface roughness to form the lipophilic portion 701. In addition, for example, when the contact angle between the fuel and the surface is larger than 90 degrees and the surface is not easily wet, the contact angle can be reduced by reducing the surface roughness, so that the lipophilic portion 701 which is relatively lipophilic can be formed. As described above, the lipophilic characteristic may be changed by changing the surface roughness according to the type of fuel and the surface.

### Sixth Embodiment

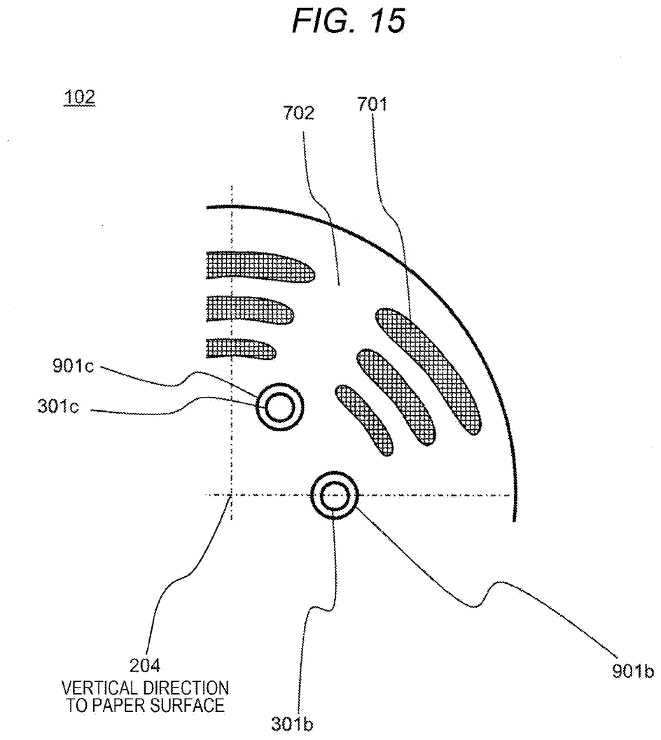

FIG. 15 illustrates a sixth embodiment according to the present invention. In the present embodiment, as illustrated in the figure, the lipophilic portion 701 is formed by a projection extending in the circumferential direction of the injection hole cup 102. Instead of the projection, however, as described in the previous embodiments, a curved surface continuously connected to the low lipophilic portion 702, or a region having a higher lipophilic characteristic than the low lipophilic portion 702 by surface treatment may be used. In the present embodiment, the lipophilic portions 701 are formed in the circumferential direction, but the lipophilic portions 701 may not extend in the circumferential direction. Alternatively, the lipophilic portions 701 extend, for example, in a radial direction or in both the radial direction and the circumferential direction.

### Seventh Embodiment

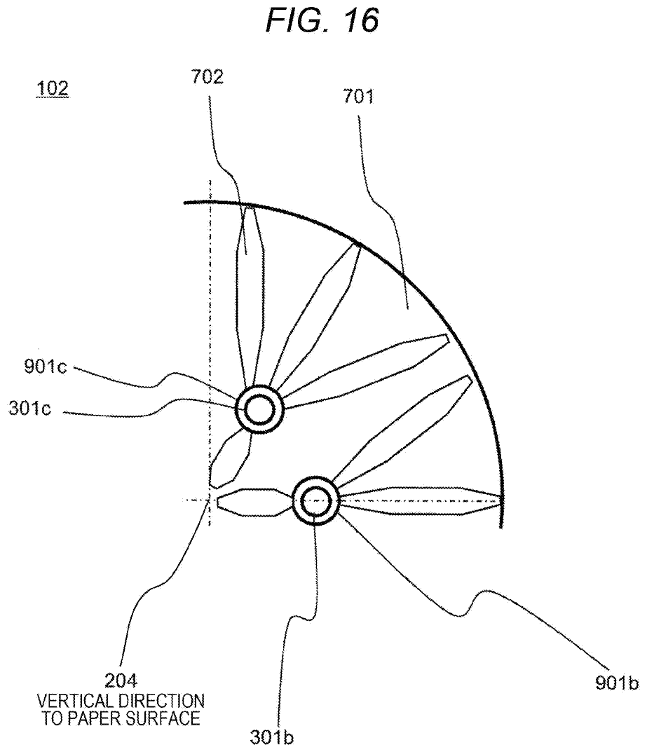

FIG. 16 illustrates a seventh embodiment according to the present invention. In the present embodiment, the low lipophilic portion 702 is formed by grooves formed approximately radially from the opening 901. Specifically, in the present embodiment, as illustrated in FIG. 16, the low lipophilic portion 702 is formed by one or more grooves, and the width of the low lipophilic portion 702 narrows with distance from the injection hole as the low lipophilic portion 702 is away from the injection hole 301 when the low lipophilic portions are away from the injection hole by more than a predetermined distance. Further, the low lipophilic portion 702 is formed by one or more grooves, and it is desirable that the width of the low lipophilic portion 702 narrows with distance as the low lipophilic portion 702 approaches the injection hole 301 by more than a predetermined distance from the injection hole 301. Preferably, the low lipophilic portion 702 extends approximately radially from the injection hole 301 in at least one of a central direction or an outer peripheral direction of the injection hole cup 102.

Since one end of the low lipophilic portion 702 is connected to the opening 901 of the injection hole 301, the fuel is removed from the surface 121 of the injection hole cup 102 by the cleaning effect by spraying via the low lipophilic portion 702. Since the deposit is formed preferentially in the lipophilic portion 701, the cleaning effect is not inhibited by the deposit, as illustrated in FIG. 7. Therefore, the present embodiment can also decrease the total amount of deposit.

Further, the low lipophilic portion 702 is formed by grooves in this embodiment, and this can be achieved by changing the surface roughness inside the groove, forming a low lipophilic film, or the like. The low lipophilic effect may be achieved without forming the groove, and by only changing the surface roughness or by surface treatment. Further, the lipophilicity may be changed relatively between 701 and 702 by increasing the lipophilicity of 701 instead of making 702 low lipophilicity.

### REFERENCE SIGNS LIST

100 electromagnetic fuel injection device
101 valve body
102 injection hole cup
103 guide member
104 nozzle body
105 valve body guide
106 movable element
107 magnetic core
108 coil
109 yoke
110 bias spring
111 connector
112 fuel supply inlet
121 valve seat surface
202 curved surface of valve body
203 valve seat surface
204 vertical center axis of fuel injection device
301 injection hole
401 counterbore portion
501 residual fuel
502 fuel
503 liquid film
555 deposit
700 columnar projection
701 lipophilic portion
702 low lipophilic portion
703 columnar projection side portion
901 opening

1. A fuel injection device, comprising: a displaceable valve body; a valve seat surface touching the valve body to seal fuel; and an injection hole cup including at least one injection hole formed on a tip side of the valve body beyond a position at which the valve seat surface touches the valve body, wherein
the injection hole cup includes a low lipophilic portion and a lipophilic portion on a surface of the injection hole cup, the lipophilic portion formed inside at least a part of a range in which the low lipophilic portion is formed, and at least one portion of the low lipophilic portion is connected to an end portion of the injection hole.

2. The fuel injection device according to claim 1, wherein
the lipophilic portion is formed by one or more approximately columnar projections.

3. The fuel injection device according to claim 1, wherein
the lipophilic portion is made of at least one particulate matter.

4. The fuel injection device according to claim 1, wherein
the lipophilic portion and the low lipophilic portion have different surface roughness values.

5. The fuel injection device according to claim 1, wherein
at least one of the lipophilic portion or the low lipophilic portion is subjected to surface treatment to change a lipophilic characteristic.

6. The fuel injection device according to claim 1, wherein
a distance between the lipophilic portions narrows with distance from the injection hole as the lipophilic portions are away from the injection hole when the lipophilic portions are away from the injection hole by more than a predetermined distance.

7. The fuel injection device according to claim 1, wherein
the distance between the lipophilic portions narrows with distance as the lipophilic portion approaches the injection hole by more than a predetermined distance.

8. The fuel injection device according to claim 1, wherein
the low lipophilic portion is formed by one or more grooves, and a width of the low lipophilic portion narrows with distance from the injection hole as the low lipophilic portion is away from the injection hole when the low lipophilic portions are away from the injection hole by more than a predetermined distance.

9. The fuel injection device according to claim 1, wherein
the low lipophilic portion is formed by one or more grooves, and a width of the low lipophilic portion narrows with distance as the low lipophilic portion approaches the injection hole by more than a predetermined distance from the injection hole.

10. The fuel injection device according to claim 1, wherein
the low lipophilic portion is formed by one or more grooves, and the low lipophilic portion expands approximately radially from the injection hole in at least one of a central direction or an outer peripheral direction of the injection hole cup.

11. The fuel injection device according to claim 2, wherein
the lipophilic portion is made of at least one particulate matter.

12. The fuel injection device according to claim 2, wherein
the lipophilic portion and the low lipophilic portion have different surface roughness values.

13. The fuel injection device according to claim 2, wherein
at least one of the lipophilic portion or the low lipophilic portion is subjected to surface treatment to change a lipophilic characteristic.

14. The fuel injection device according to claim 2, wherein
a distance between the lipophilic portions narrows with distance from the injection hole as the lipophilic portions are away from the injection hole when the lipophilic portions are away from the injection hole by more than a predetermined distance.

15. The fuel injection device according to claim 2, wherein
the distance between the lipophilic portions narrows with distance as the lipophilic portion approaches the injection hole by more than a predetermined distance.
